(19) United States
(12) Patent Application Publication
(10) Pub. No.: US 2026/0285231 A1
(43) Pub. Date: Sep. 24, 2026

(54) ELECTRONIC REARVIEW MIRROR DEVICE

(71) Applicant: TKS INDUSTRIAL CO., LTD., Tainan City (TW)

(72) Inventor: Chung-Hsu KAO, Tainan City (TW)

(21) Appl. No.: 19/269,411

(22) Filed: Jul. 15, 2025

(30) Foreign Application Priority Data
Mar. 21, 2025 (TW) 114110816

(51) Int. Cl. B60R 1/26; B60R 1/04; G02B 7/182

(52) U.S. Cl. CPC B60R 1/26; B60R 1/04; G02B 7/182; B60R 2300/20

(57) ABSTRACT

An electronic rearview mirror includes a housing unit, a display unit, a mounting unit, and an adjustment unit. The display unit includes a display panel, an imaging module, and a control switch configured to control the imaging module. The mounting unit includes a mounting panel mounted inside the housing unit and having a blocking panel surface. The adjustment unit includes two pivot blocks respectively having two engagement surface portions adjoining each other, an adjustment handle connected to the pivot blocks, and a pressing block that protrudes from the adjustment handle. The adjustment handle is operable to convert between a first position where one of the engagement surfaces abuts against the blocking panel surface, and the pressing block unpresses the control switch, and a second position where another one of the engagement portions abuts against the blocking panel surface, and the pressing block presses the control switch.

### CROSS-REFERENCE TO RELATED APPLICATION

This application claims priority to Taiwanese Invention Patent Application No. 114110816, filed on Mar. 21, 2025, the entire disclosure of which is incorporated by reference herein.

### FIELD

The disclosure relates to a rearview mirror, and more particularly to an electronic rearview mirror.

### BACKGROUND

Vehicles such as automobiles usually have a rearview mirror which allows the driver of the automobile to see rearward. As technology has advanced in this area, electronic rearview mirrors have been developed that uses a camera to record and broadcast the environment outside the vehicle onto a display. Referring to FIG. 1, a conventional electronic rearview mirror includes a shell body 11, a display 12, a camera (not shown), an imaging module 13, a switch 14, and a connector rod 15. The display 12 is mounted to the shell body 11 and that is facing rearward relative to a vehicle. The imaging module 13 is disposed in the shell body 11, and is signally connected to the display 12 and the camera. The camera is mounted on the vehicle facing rearward. The switch 14 is disposed on an outer periphery of the shell body 11, protrudes from the shell body 11, and is used to control the imaging module 13. The connector rod 15 is connected to the shell body 11 and is multi-directionally rotatable.

When the vehicle is driving under normal conditions, the display 12 may be used as a mirror showing a rear image of the road conditions behind the vehicle via reflection so that a driver of the vehicle may asses the traffic conditions behind the vehicle. The driver may manually adjust the shell body 11 by directly grabbing and applying force on the shell body 11, this may swivel the shell body 11 and the display 12 mounted to the shell body 11 relative to the connector rod 15. In doing so, the driver may change the viewing angle of the display 12 and the conventional electronic rearview mirror may be adjusted according to the driver's driving habits. However, when the vehicle is about to be parked and the driver prepares to conduct reverse parking, the switch 14 may be pressed to change the display 12 from reflecting a rear image to displaying a live-feed recording from the camera. The live-feed recording from the camera has the advantage of not having blind spots and may assist the drive in reverse parking.

However, when the changing of the display 12 from reflecting the rearview image to displaying the live-feed is associated with a change in driving conditions such as reversing the car or reverse parking. In these situations, the driver often needs to adjust the viewing angle of the display 12 for better visibility, and the operating of the switch 14 while grabbing and swiveling the shell body 11 may be complicated for the driver to execute. Additionally, if the driver presses the switch 14 with too much force, the shell body 11 may swivel and the viewing angle of the display 12 may deviate from the desired setting. Furthermore, when the driver grabs the shell body 11 to adjust the viewing angle of the display 12, there is the risk that the switch 14 may accidentally be activated. Therefore, there is room for improvement of the conventional electronic rearview mirror.

### SUMMARY

Therefore, an object of the disclosure is to provide an electronic rearview mirror that can alleviate at least one of the drawbacks of the prior art.

According to the disclosure, the electronic rearview mirror includes a housing unit, a display unit, a mounting unit, and an adjustment unit. The housing unit includes a rear side, a front side, and an accommodation space between the rear side and the front side. The display unit includes a display panel, an imaging module, and a control switch. The display panel is fixed to the rear side of the housing unit. The imaging module is disposed in the accommodation space and is signally connected to the display panel. The control switch is configured to control the imaging module and protrudes in a direction towards the front side of the housing unit from the imaging module. The mounting unit includes a mounting panel, and a position seat. The mounting panel is mounted inside the housing unit and that has a blocking panel surface facing the front side of the housing unit. The positioning seat is located in front of the mounting panel and includes a seat body portion secured inside the housing unit in front of the mounting panel, and two guiding portions that are connected to the seat body portion and spaced apart from each other. Each of the two guiding portions extend curvedly from the seat body portion in a cantilever manner, and has a concave sliding surface that is curved and that faces the blocking panel surface, and a convex sliding surface that is opposite to the concave sliding surface. The adjustment unit includes two pivot blocks, an adjustment handle, two limiting blocks, and a pressing block. The two pivot blocks are each rotatably confined between a respective one of the two guiding portions of the positioning seat and the mounting panel. The adjustment handle is located between the two guiding portions and has left and right sides respectively connected to the two pivot blocks. The two limiting blocks respectively protrude leftward and rightward from the adjustment handle so as to respectively extend over the convex sliding surfaces of the two guiding portions. The pressing block protrudes from the adjustment handle and is located forwardly of the control switch of the display unit. Each of the pivot blocks has a rotatable peripheral surface that has two engagement surface portions adjoining each other, and a curved sliding surface portion that has two opposite ends respectively connecting with the two engagement surface portions and that is in sliding contact with the concave sliding surface of the respective one of the two guiding portions. The adjustment handle is operable to convert between a first position and a second position. When the adjustment handle is in the first position, one of the two engagement surface portions abuts against the blocking panel surface, and the pressing block unpresses the control switch. When the adjustment handle is in the second position, another one of the two engagement surface portions abuts against the blocking panel surface, and the pressing block presses the control switch.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic perspective view illustrating a conventional electronic rearview mirror.

FIG. 2 is a perspective view illustrating an embodiment of an electronic rearview mirror according to the present disclosure.

FIG. 3 is a fragmentary cross-sectional view illustrating the embodiment where an adjustment handle is in a first position

FIG. 4 is a fragmentary cross-sectional view illustrating the embodiment.

FIG. 5 is a fragmentary schematic side view illustrating the embodiment.

FIG. 6 is a fragmentary perspective view illustrating the embodiment.

FIG. 7 is a cross-sectional view illustrating a connecting unit of the embodiment.

FIG. 8 is a fragmentary cross-sectional view illustrating the embodiment where the adjustment handle is in a second position.

FIG. 9 illustrates in more detail an adjustment unit and a mounting frame of the embodiment.

FIGS. 10 and 11 illustrate in more detail a pivot block, an extending panel portion and a guiding portion of the embodiment.

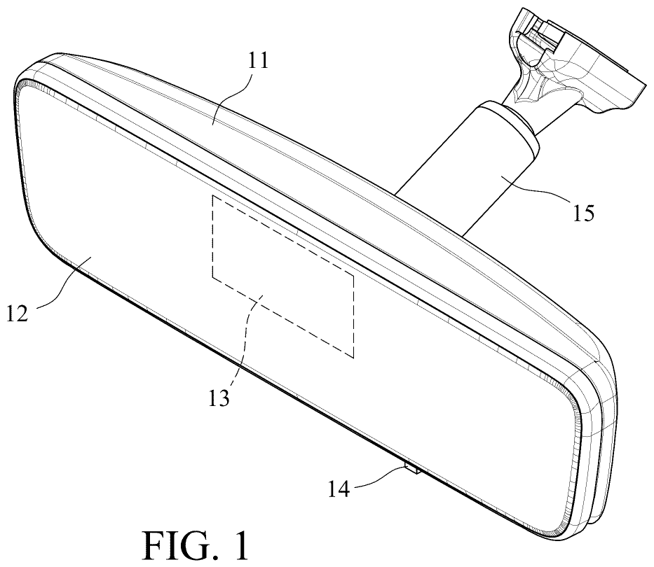

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted

### Accordingly.

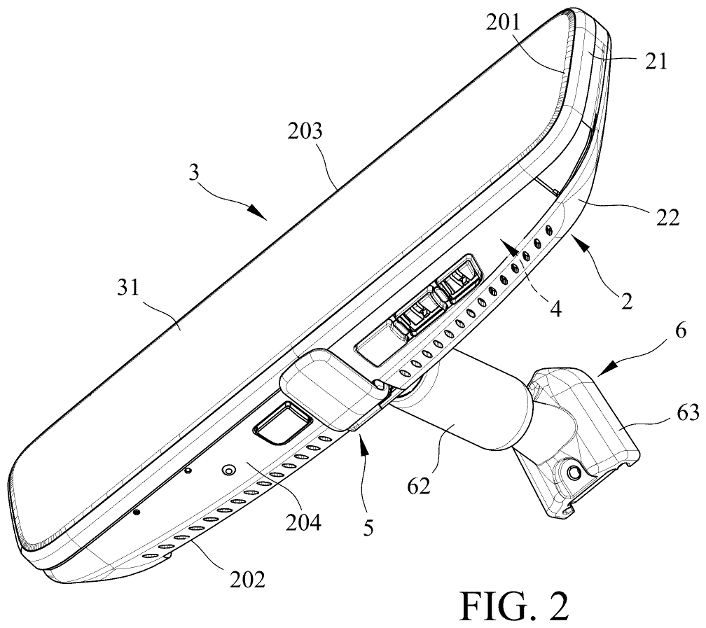

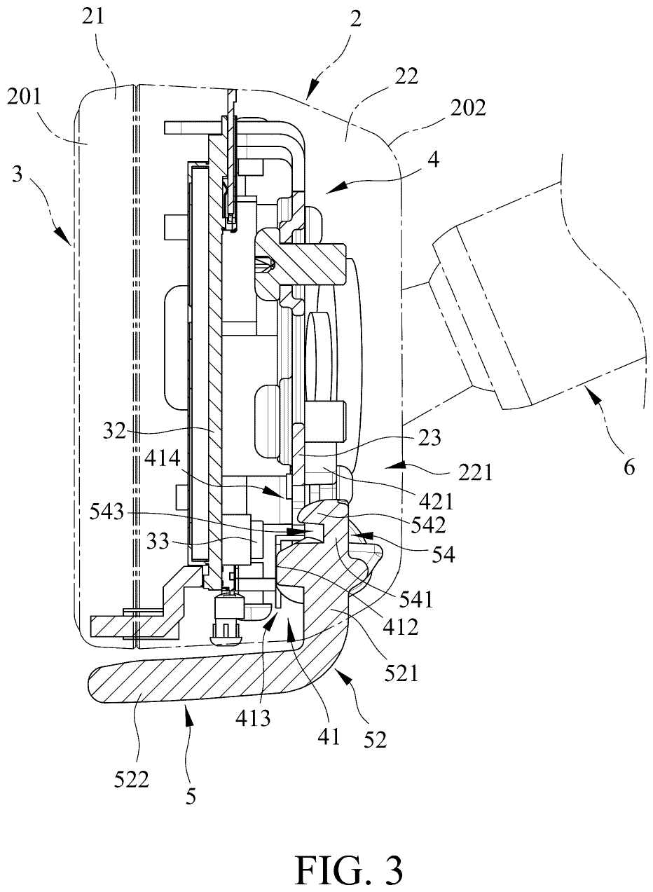

Referring to FIGS. 2 and 3, an embodiment of an electronic rearview mirror according to the present disclosure includes a housing unit 2, a display unit 3, a mounting unit 4, and an adjustment unit 5, and a connecting unit 6. It should be noted that in this disclosure the spatial terms forward (forwardly) and rearward (rearwardly) is based on the rearview mirror after it has been installed in a vehicle or car and the terms forward (forwardly) and rearward (rearwardly) is relative to the travelling direction of the vehicle or car. The display unit 3 is mounted to the housing unit 2. The mounting unit 4 is mounted inside the housing unit 2. The adjustment unit 5 is mounted on the mounting unit 4. The connecting unit 6 is connected to the housing unit 2. The housing unit 2 includes a rear side 201, a front side 202, a top side 203, a bottom side 204 and an accommodation space 221 located between the rear side 201 and the front side 202. The housing unit 2 further includes a shell 21, a cover 22, and a mounting frame 23. The shell 21 defines the rear side 201 of the housing unit 2. The cover 22 is assembled with the shell 21, located forwardly of the shell 22, and defines the front side 202 of the housing unit 2. The shell 21 and the cover 22 cooperatively defines the accommodation space 221. The mounting frame 23 is located in the accommodation space 221 and is secured to the shell 21. In this embodiment, the mounting frame 23 is secured to the shell 21; however, in other embodiments, the mounting frame 23 may be secured to the cover 22 according to practical requirements.

The display unit 3 includes a display panel 31, an imaging module 32, and a control switch 33. The display panel 31 is fixed to the rear side 201 of the housing unit 2. More specifically, the display panel 31 is fixed to the shell 21 of the housing unit 2. The imaging module 32 is disposed forwardly of the display panel 31 and rearwardly of the mounting frame 23 in the accommodation space 221 and is signally connected to the display panel 31. The control switch 33 is configured to control the imaging module 32 and protrudes in a direction toward the front side 202 of the housing unit 2 from the imaging module 32. The imaging module 32 may be signally connected to a camera mounted to the exterior of the vehicle, and the control switch 33 may be pressed to change the content displayed on the display panel 31. For example, the control switch 33 may be pressed to turn on or turn off the display panel 31 so that it may be used as a physical rearview mirror showing a reflection of a rearview of the vehicle or a digital display showing the live-feed video recorded by the camera. In this embodiment the camera may record a rear view of the vehicle to assist a driver of the vehicle when reverse parking.

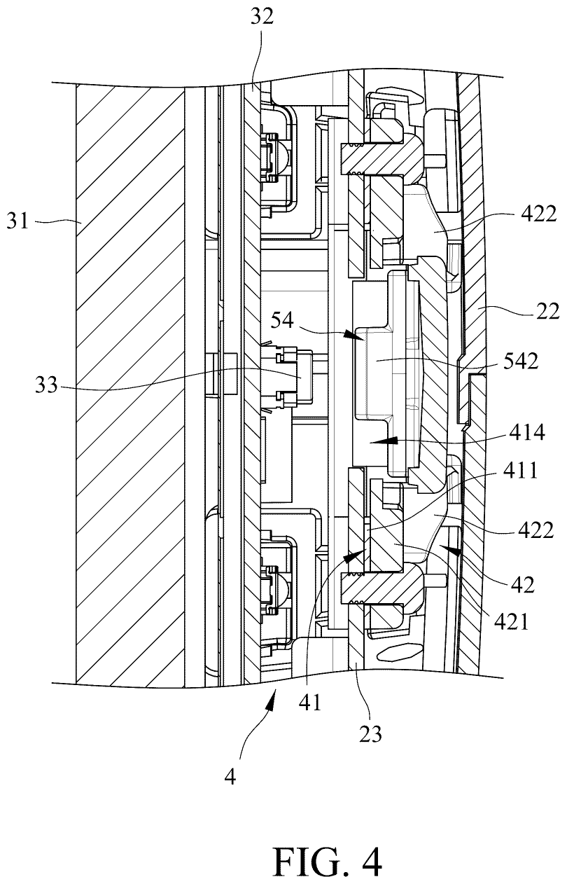

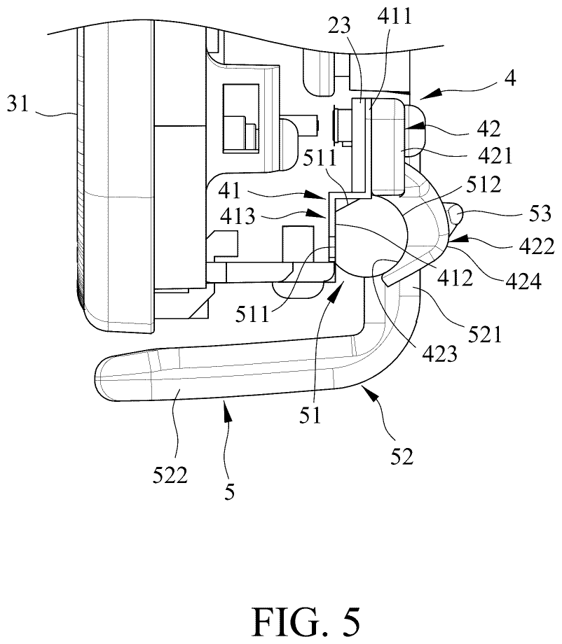

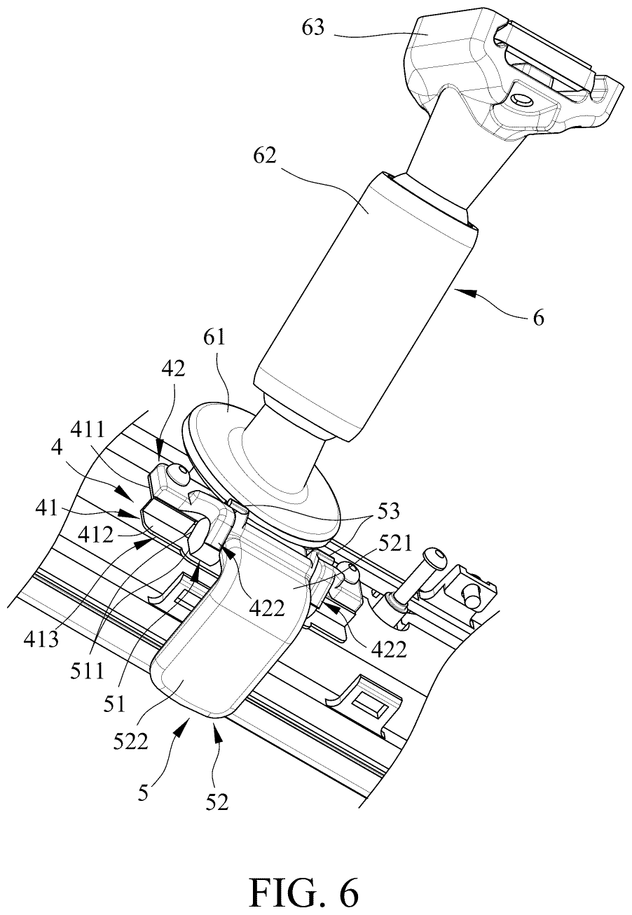

Referring to FIGS. 3 to 6, the mounting unit 4 includes a mounting panel 41, and a positioning seat 42. The mounting panel 41 is mounted inside the housing unit 2. The positioning seat 42 is mounted on the housing unit 2 and is located in front of the mounting panel 41. In this embodiment, the mounting panel 41 and the positioning seat 42 may be secured together to the mounting frame 23. However, in other embodiments the mounting panel 41 and the positioning seat 42 may be secured to the cover 22. The mounting panel 41 of the mounting unit 4 has a mounting panel portion 411, a blocking panel surface 412, an extending panel portion 413, and a through hole 414. The mounting panel portion 411 is secured to the mounting frame 23 of the housing unit 2. The blocking panel surface 412 faces the front side 202 of the housing unit 2. The extending panel portion 413 has the blocking panel surface 412 and is connected to the mounting panel portion 411. The extending panel portion 413 is located in front of the control switch 33 of the display unit 3. The through hole 414 is formed through the mounting panel portion 411 in a direction from the rear side 201 to the front side 202 and that is located in front of the control switch 33. More specifically, the through hole 414 is formed through the mounting frame 23 and the mounting panel 41. In some embodiments, where mounting panel 41 and the positioning seat 42 are secured to the cover 22, the through hole 414 is formed by the extending panel portion 413 and the cover 22, cooperatively. The positioning seat 42 includes a seat body portion 421 secured inside the housing unit 2 in front of the mounting panel 41, and two guiding portions 422 that are connected to the seat body portion 421 and spaced apart from each other. The mounting panel portion 411 is secured to the housing unit 2 together with the seat body portion 421 of the positioning seat 42. In this embodiment, the mounting panel portion 411 is secured to the mounting frame 23 of the housing unit 2 together with the seat body portion 421. Each of the two guiding portions 422 extend curvedly and downwardly from a bottom portion of the seat body portion 421 in a cantilevered manner. Each of the two guiding portions 422 has a concave sliding surface 423 that is curved and that faces the blocking panel surface 412, and a convex sliding surface (424) that is opposite to the concave sliding surface 423.

The adjustment unit 5 includes two pivot blocks 51, an adjustment handle 52, two limiting blocks 53, and a pressing block 54. The two pivot blocks 51 are each rotatably confined between a respective one of the two guiding portions 422 of the positioning seat 42 and the mounting panel 41. The adjustment handle 52 is located between the two guiding portions 422 and has left and right sides respectively connected to the two pivot blocks 51. The two limiting blocks 53 respectively protrude leftward and rightward from the adjustment handle 52 so as to extend over the convex sliding surfaces (424) of the two guiding portions 422. The pressing block 54 protrudes from the adjustment handle 52 and is located forwardly of the control switch 33 of the display unit 3. The pivot blocks 51 of the adjustment unit 5 are respectively located rearwardly of the guiding portions 422 of the positioning seat 42, and the limiting blocks 53 of the adjustment unit 5 are respectively located in front of the guiding portions 422 of the positioning seat 42.

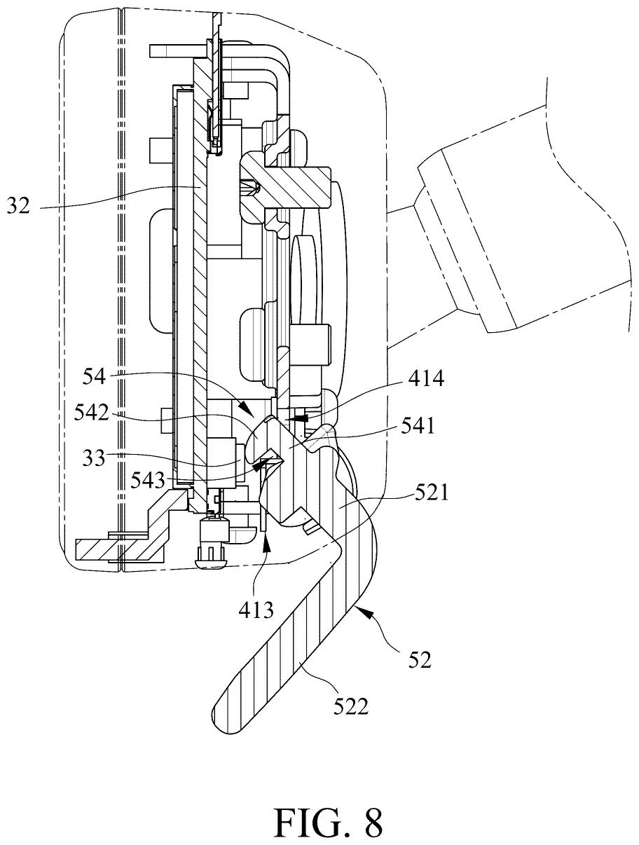

The extending panel portion 413 of the mounting panel 41 is located rearwardly of the pivot blocks 51. Each of the pivot blocks 51 has a rotatable peripheral surface that has two engagement surface portions 511 that are flat surfaces and that adjoin and are inclined to each other at an obtuse angle corner, and a curved sliding surface portion 512 that has two opposite ends respectively connecting with the two engagement surface portions 511 and that is in sliding contact with the concave sliding surface 423 of the respective one of the two guiding portions 422. Each pivot block 51 is rotatably clamped between the respective guiding portion 422 of the positioning seat 42 and the blocking panel surface 412 of the extending panel portion 413 of the mounting panel 41. The two engagement surfaces 511 can interchangeably abut the blocking panel surface 412 of the extending panel portion 413 when an external force is applied to the adjustment handle 52 to rotate the pivot blocks 52 (see FIGS. 3, 5 and 8). Because each guiding portion 422 protrudes from the seat body portion 421 in a cantilever manner, it is slightly resilient and is thus slightly movable outward away from the blocking panel surface 412 by the external force to allow the engagement surfaces 511 to change their positions.

The adjustment handle 52 of the adjustment unit 5 has a connecting section 521, and a lever handle section 522. The connecting section 521 is connected to each of the pivot blocks 51, each of the limiting blocks 53, and the pressing block 54. The lever handle section 522 bendingly extends from the connecting section 521 and extends outwardly from the accommodation space 221. In this embodiment, the lever handle section 522 bends in an L-shape from the proximal portion 521a of the connecting section 521 and a cross-section of the adjustment handle 52 in a left-right direction is substantially L-shaped. The pressing block 54 of the adjustment unit 5 has an extending section 541 that is connected to the connecting section 521 of the adjustment handle 52, and a protruding hooked section 542 that bendingly extends from the extending section 541. The connecting section 521 and the protruding hooked section 542 cooperatively defines a notch 543. In this embodiment, the protruding hooked section 542 is tapered toward a tip.

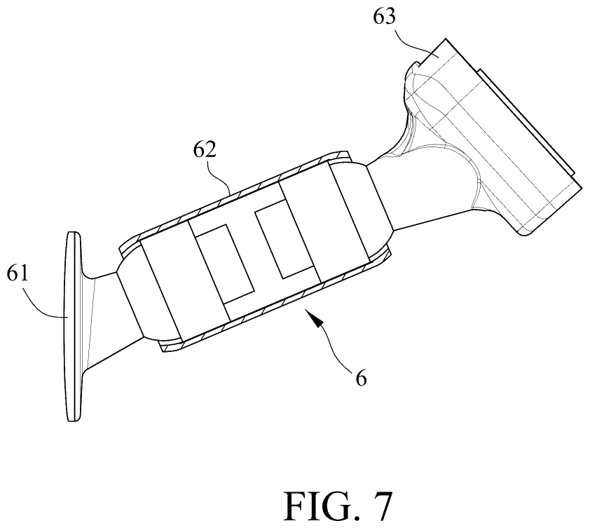

Referring to FIGS. 3, 6 and 7, the connecting unit 6 is connected to the housing unit 2, and includes a support seat 61, a joint sleeve 62, and a connector seat 63. The support seat 61 is secured to the mounting frame 23 of the housing unit 2. The joint sleeve 62 is connected to the support seat 61 in a universally rotatable manner. The connector seat 63 is connected to the joint sleeve 62 in a universally rotatable manner, and is secured to an inside of the vehicle. In some embodiments, the support seat 61 of the connecting unit 6 may be secured to the cover 22 of the housing unit 2 according to practical requirements. The joint sleeve 62 may be connected to the support seat 61 and the connector seat 63 via ball joints or universal joints which may allow the joint sleeve 62 to be omni-directionally rotatable relative to the support seat 61 and the connector seat 63.

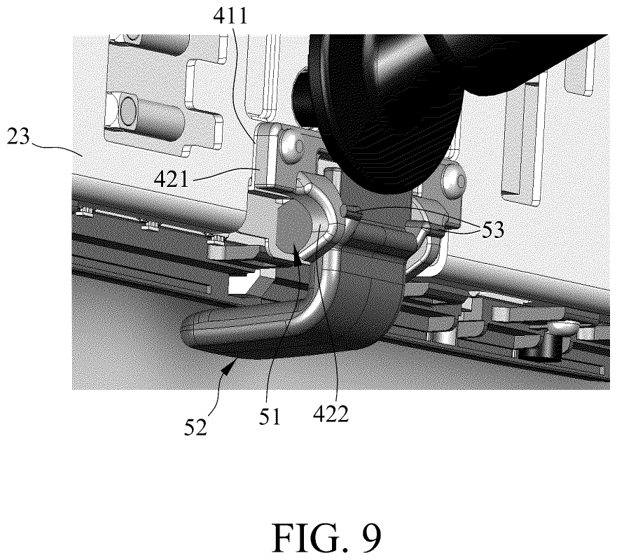

Referring to FIGS. 3, 5, 8 and 9, because the pivot blocks 51 are respectively located rearwardly of the guiding portions 422 and the limiting blocks 53 are respectively located forwardly of the guiding portions 422, and because the adjustment handle 52 is located between the two guiding portions 422 and has left and right sides respectively connected to the two pivot blocks 51, the adjustment handle 52 has limited degrees of freedom. In other words, the roll and yaw movements are restricted and the adjustment handle 52 can only rotate with a pitch movement relative to the mounting unit 4. The pivot blocks 51 are similarly limited to pitch movements due to the respective concave sliding surfaces 423 of the guiding portions 422. More specifically, the adjustment handle 52 is operable to convert between a first position and a second position. When the adjustment handle 52 is in the first position, one of the two engagement surface portions 511 abuts against the blocking panel surface 412, and the pressing block 54 unpresses the control switch 33. When the adjustment handle 52 is in the second position, another one of the two engagement surface portions 511 abuts against the blocking panel surface 412, and the pressing block 54 presses the control switch 33. More specifically, when the adjustment handle 52 is in the first position, the pressing block 54 of the adjustment unit 50 is located in front of the through hole 414 and does not extend through the through hole 414, and when the adjustment handle 52 is moved from the first position to the second position, the pressing block 54 of the adjustment unit 5 is moved rearwardly through the through hole 414 and presses the control switch 33. In more detail, when the adjustment handle 52 is in the first position, the connecting section 521 of the adjustment handle 52 extends upward and toward the top side 203 of the housing unit 2 from the lever handle section 522, the lever handle section 522 extends rearwardly in proximity to an outer surface of the housing unit 2, and the extending section 541 of the pressing block 54 extends upward and toward the top side 203 of the housing unit 2 from the connecting section 521 to be in an upward position. The protruding hooked section 542 and the notch 543 are positioned in front of the through hole 414 (or in the through hole 414), and the tip of the protruding section 542 is pointed rearwardly without extending through the through hole 414. This configuration will allow the pressing block 54 to not contacting (not press) the control switch 33. When the pressing block 54 is unpressing the control switch 33, the imaging module 32 does not turn on the display panel 31, and the display panel 31 may reflect a rearview of the vehicle as a normal physical mirror. When the adjustment handle 52 is moved from the first position to the second position, the lever handle section 522 is inclined rearwardly and downwardly and extends away from the outer surface of the housing unit 2, the extending section 541 turns rearwardly and downwardly from the upward position, passes through the through hole 414 so that the protruding hooked section 542 is positioned rearwardly of the through hole 414, and the tip of the protruding hooked section 542 is pointed downwardly to press the control switch 33. In some embodiments, when the adjustment handle 52 is being moved from the first position to the second position, the notch 543 moves rearward so that the extending panel portion 413 of the mounting panel 41 is partially received in the notch 543 (depending on the degree of movement between the first position and the second position); however, this is not a limitation of the disclosure. When the adjustment handle 52 is moved to the second position, the imaging module 32 switches on the display panel 31 so that the display panel 31 displays a real time video recorded by the camera after the control switch 33 has been pressed.

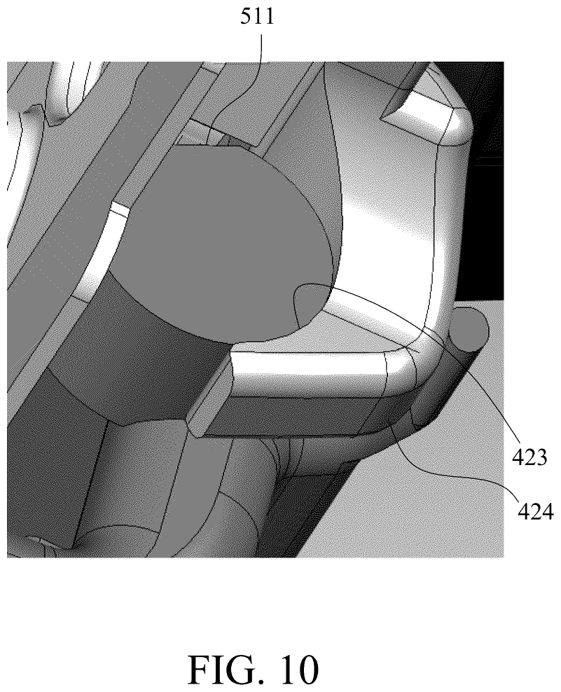

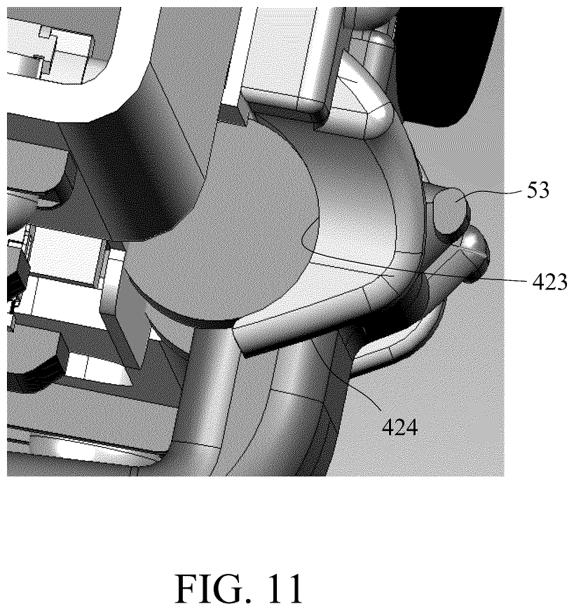

Referring to FIGS. 2, 3, 5, 10 and 11, when changing the position of the adjustment handle 52 from the first positon to the second position to change the function of the display panel 31, the connecting unit 6 and the housing body 2 may be moved simultaneously so as to adjust the angle of the display panel 31. In this way, the two operations of switching the function and adjusting the angle of the display panel 31 may be accomplished at the same time. This provides the driver of the vehicle with simplified operation procedures and increases the ease of operating the electronic rearview mirror. This also prevents a problem caused by direct pressing of the control switch 33, which may change or skew the angle of the display panel 31 if too much force is applied. The design of the adjustment handle 52 in a substantially L-shape also allows the driver to operate the adjustment handle 51 with only his/her index finger and thumb. This may prevent the driver from accidentally switching on or turning off the display panel 31 while trying to adjust its angle. When the adjustment handle 52 of the adjustment unit 5 is operated to convert between the first position and the second position, the curved sliding surface portion 512 of each of the pivot blocks 51 remains in sliding contact with the concave sliding surface 423 of the respective one of the two guiding portions 422, and each of the limiting blocks 53 slides along the convex sliding surface 424 of the respective one of the guiding portions 422. These designs allow the pivot blocks 51 to pivot with only a single degree of freedom and prevents tilting in other directions, and thereby helps the pivot blocks 51 to maintain smooth movement while pivoting. One of the two engagement surface portions 511 abuts against the blocking panel surface 412 when the adjustment handle 52 is in the first position and another of the two engagement surface portions 511 abuts against the blocking panel surface 412 when the adjustment handle is in the second positon. This design provides the driver with tactile feedback when operating the adjustment handle 52 to convert between the first and second positions so that the driver can accurately feel when the adjustment handle 52 has been converted into the first position or the second position. This also prevents the adjustment handle 52 from converting between the first and second positions due to accidental manipulation or vibration. This is an important feature of the electronic rearview mirror, since the display panel 31 suddenly turning on or off during driving or when reverse parking may be seriously disruptive to the driver.

The design of the protruding hooked section 542 being tapered toward the tip allows the protruding hooked section 542 to move freely along with the adjustment handle 52 during conversion and be unobstructed by the mounting frame 23 or the extending panel portion 413. When the adjustment handle 52 is operated to convert from the first position to the second positon, the protruding tapering tip of the protruding hooked section 542 allows the protruding hooked section 542 to gradually apply more pressure on the control switch 33, and control switch 33 will be activated/pressed only when the protruding hooked section 542 is almost completely pointed downwardly and exerting the most amount of pressure on the control switch 33. This allows the driver operating the conversion of the adjustment handle 52 to gauge accurately when the activation/pressing of the control switch 33 will happened. With this design, because the protruding hooked section 542 may apply gradual pressure on the control switch 33, the control switch 33 may be designed to have more functions other than controlling the imaging module 32 switch on and display real time video on the display panel 31, or controlling the imaging module 32 to switch off. For example, the control switch 33 may control the switching module 32 to offer different functionalities according to the amount of pressure being applied to it, such as brightness adjustment or changing between different functions. In some embodiments, the above designs may be combined with the pivot blocks 51 having more than two engagement surface portions 511 so that the adjustment handle 52 may be operated to convert between multiple functionalities and change between multi-stage settings which may increase the adaptability of the electronic rearview mirror.

In summary of the above, in the electronic rearview mirror according to the present disclosure, the driver of the vehicle may switch on the display panel 31 to display a real time video of the rear of the vehicle or switch off the display panel 31 to view a rearview reflection of the vehicle while changing the angle of the display panel 31 at the same time. This simplifies the operating procedure of the electronic rearview mirror and increases its ease of use. In addition to the above, the adjustment handle 52 is restricted to move with a single degree of freedom, this ensures the movement of the adjustment handle 52 is smooth and prevents tilting. Furthermore, in the electronic rearview mirror, the design of the engagement surface portions 511 and the blocking panel surface 412 allows the driver to sense tactilely whether the adjustment handle 52 has been positioned correctly to ensure functionality, and prevents the adjustment handle 52 from snapping back or reverting due to insufficient positioning. The objectives of the disclosure are have therefore been achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electronic rearview mirror comprising:
a housing unit including a rear side, a front side, and an accommodation space located between said rear side and said front side;
a display unit including a display panel that is fixed to said rear side of said housing unit, an imaging module that is disposed in said accommodation space and that is signally connected to said display panel, and a control switch that is configured to control said imaging module and that protrudes in a direction toward said front side of said housing unit from said imaging module;
a mounting unit including
a mounting panel that is mounted inside said housing unit and that has a blocking panel surface facing said front side of said housing unit, and
a positioning seat that is located in front of said mounting panel, and that includes a seat body portion secured inside said housing unit in front of said mounting panel, and two guiding portions that are connected to said seat body potion and spaced apart from each other, each of said two guiding portions protruding curvedly from said seat body portion in a cantilevered manner, and having a concave sliding surface that is curved and that faces said blocking panel surface, and a convex sliding surface opposite to said concave sliding surface; and
an adjustment unit including
two pivot blocks that are each rotatably confined between a respective one of said two guiding portions of said positioning seat and said mounting panel, an adjustment handle that is located between said two guiding portions and that has left and right sides respectively connected to said two pivot blocks, two limiting blocks that respectively protrude leftward and rightward from said adjustment handle, so as to respectively extend over said convex sliding surfaces of said two guiding portions, and a pressing block that protrudes from said adjustment handle and that is located forwardly of said control switch of said display unit, each of said pivot blocks having a rotatable peripheral surface that has two engagement surface portions adjoining each other, and a curved sliding surface portion that has two opposite ends respectively connecting with said two engagement surface portions and that is in sliding contact with said concave sliding surface of a respective one of said two guiding portions;
wherein said adjustment handle is operable to convert between a first position and a second position;
when said adjustment handle is in the first position, one of said two engagement surface portions abuts against said blocking panel surface, and said pressing block unpresses said control switch; and
when said adjustment handle is in the second position, another one of said two engagement surfaces portions abuts against said blocking panel surface, and said pressing block presses said control switch.

2. The electronic rearview mirror as claimed in claim 1, wherein:
said pivot blocks of said adjustment unit are respectively located rearwardly of said guiding portions of said positioning seat, and said limiting blocks of said adjustment unit are respectively located in front of said guiding portions of said positioning seat;
when said adjustment handle of said adjustment unit is operated to convert between the first position and the second position, said curved sliding surface portion of each of said pivot blocks remains in sliding contact with said concave sliding surface of said respective one of said two guiding portions, and each of said limiting blocks slides upward or downward along said convex sliding surface of the respective one of said guiding portions.

3. The electronic rearview mirror as claimed in claim 1, wherein:
said adjustment handle of said adjustment unit has a connecting section that is connected to each of said pivot blocks, each of said limiting blocks, and said pressing block and that is positioned between said guiding portions, and a lever handle section that is disposed outwardly of said accommodation space below a bottom side of said housing unit and bendingly extends from said connecting section; and
when said adjustment handle is in the first position, said lever handle section extends rearwardly in proximity to said bottom side of said housing unit, and when said adjustment handle is in the second position, said lever handle section is inclined to extend away from said bottom side of said housing unit.

4. The electronic rearview mirror as claimed in claim 3, wherein:
said mounting panel of said mounting unit has
a mounting panel portion that is secured to said housing unit together with said seat body portion of said positioning seat,
an extending panel portion that is connected to said mounting panel portion, that has said blocking panel surface, that is located in front of said control switch of said display unit, and
a through hole that is formed through said mounting panel portion in a direction from said rear side to said front side and that is located in front of said control switch;
when said adjustment handle is in the first position, said pressing block of said adjustment unit is located in front of said through hole and does not extend through said through hole, and when said adjustment handle is moved from the first position to the second position, said pressing block of said adjustment unit is moved rearwardly through said through hole and presses said control switch.

5. The electronic rearview mirror as claimed in claim 4, wherein:
said pressing block of said adjustment unit has an extending section that is connected to said connecting section of said adjustment handle, and a protruding hooked section that bendingly extends from said extending section, said connecting section and said protruding hooked section cooperatively defining a notch;
when said adjustment handle is in the first position, said connecting section of said adjustment handle extends upward from said lever handle section, and said extending section of said pressing block extends upward from said connecting section to be in an upward position, said protruding hooked section is positioned in front of said through hole, a tip of said protruding hooked section is pointed rearwardly without extending through said through hole; and
when said adjustment handle is moved from the first position to the second position, said extending section turns rearwardly and downwardly from said upward position, passes through said through hole so that said protruding hooked section is positioned rearwardly of said through hole, and said tip of said protruding hooked section is pointed downwardly to press said control switch.

6. The electronic rearview mirror as claimed in claim 5, wherein said protruding hooked section is tapered toward said tip.

7. The electronic rearview mirror as claimed in claim 5, wherein said housing unit further has a mounting frame located in said accommodation space, said mounting panel and said positioning seat being secured together to said mounting frame, said through hole being formed through said mounting frame and said mounting panel.

8. The electronic rearview mirror as claimed in claim 1, wherein:
said housing unit further includes
a shell that defines said rear side of said housing unit,
a cover that is assembled with said shell, located forwardly of said shell, and defining said front side of said housing unit, and
a mounting frame that is located in said accommodation space, and that is secured to one of said shell and said cover; and
said display panel of said display unit is fixed to said shell, said shell and said cover cooperatively defining said accommodation space, said imaging module being disposed forwardly of said display panel and rearwardly of said mounting frame.

9. The electronic rearview mirror as claimed in claim 8, wherein said mounting panel and said positioning seat are secured together to said mounting frame.

10. The electronic rearview mirror as claimed in claim 1, further comprising a connecting unit connected to said housing unit, and including a support sea that is secured to said housing unit, a joint sleeve that is connected to said support seat in a universally rotatable manner, and a connector seat that is connected to said joint sleeve in a universally rotatable manner.

11. The electronic rearview mirror as claimed in claim 1, wherein said two engagement surface portions of each of said pivot blocks are flat surfaces and are inclined to each other at an obtuse angle corner.
